(19) United States
(12) Patent Application Publication
(10) Pub. No.: US 2019/0046979 A1
(43) Pub. Date: Feb. 14, 2019

(54) MICROFLUIDIC DEVICE

(71) Applicant: Group K Diagnostics, Inc., Philadelphia, PA (US)

(72) Inventor: Brianna Wronko, Philadelphia, PA (US)

(21) Appl. No.: 16/161,262

(22) Filed: Oct. 16, 2018

Related U.S. Application Data
(63) Continuation of application No. 16/016,637, filed on Jun. 24, 2018.
(60) Provisional application No. 62/573,997, filed on Oct. 18, 2017.
(60) Provisional application No. 62/523,812, filed on Jun. 23, 2017.

(51) Int. Cl. B01L 3/00

(52) U.S. Cl. CPC B01L 3/50273; B01L 2300/165; B01L 2300/0681; B01L 2300/0864; B01L 2200/087; B01L 3/502707; B01L 3/5023

(57) ABSTRACT

The disclosure relates to a microfluidic device for detecting and/or quantifying an analyte, wherein the microfluidic device includes a hydrophilic substrate having a main channel, at least two fluid transfer channels fluidically coupled to the main channel, and a separate diagnostic area fluidically coupled to each fluid transfer channel; wax on a surface of the hydrophilic substrate, the wax defining boundaries of the main channel, the at least two fluid transfer channels, and the diagnostic areas; a wax backing on an opposite surface of the hydrophilic substrate; at least one assay reagent provided within at least one of the diagnostic areas; and optionally a calibration region.

This application is a continuation of U.S. patent application Ser. No. 16/016,637 filed Jun. 24, 2018, which claims the benefit of priority to U.S. Provisional Patent Application No. 62/573,997 filed Jun. 23, 2017, the disclosures of which are hereby incorporated by reference in their entireties.

### BACKGROUND

Point-of-care (POC) diagnostics are inherently attractive in many resource-limited settings where the healthcare, transportation, and distribution infrastructure is underdeveloped and underfunded. The main advantage of a POC diagnostic is the ability to diagnose disease without the support of a laboratory infrastructure; this increases access, removes the need for sample transport, and shortens turnaround times from weeks (or months) to hours or minutes. As a result, more patients are effectively diagnosed, enabling faster and more complete treatment. Although commercial paper-based sensors have been around for about 25 years (e.g., urinalysis dip sticks few paper POC devices have been successfully commercialized. Such failure to produce accurate paper POC devices is a combination of many factors, including poor limits of detection (LOD), high non-specific adsorption (NSA), unstable reagents, long analysis time, complex user-technology interface, detection method, and poor sensitivity. There is a need for paper point-of-care devices that are cheap, user friendly, robust, sensitive, stable and portable. Such devices pose an effective solution to the existing economic and healthcare accessibility problems in underdeveloped countries, as well as the growing trend in more affluent societies to become better informed in terms of its health and provide faster diagnosis.

### SUMMARY

In one aspect of the present disclosure is a microfluidic device comprising: a hydrophilic substrate, the hydrophilic substrate comprising a main channel, at least two fluid transfer channels fluidically coupled to the main channel, and a diagnostic area fluidically coupled to each fluid transfer channel; wax on the hydrophilic substrate, the wax defining boundaries of the main channel, boundaries of the at least two fluid transfer channels, and boundaries of the diagnostic areas; a wax backing beneath the hydrophilic substrate; at least one liver function assay reagent provided within at least one of the diagnostic areas; and wherein the microfluidic device further comprises a calibration region. In some embodiments, the at least one liver function assay reagent includes one or more dyes.

In some embodiments, the microfluidic device further comprises a fluid inlet. In some embodiments, the microfluidic device further comprises a filter fluidically coupled to the fluid inlet and the main channel. In some embodiments, each fluid transfer channel comprises an anti-coagulant component. In some embodiments, the anti-coagulant component is EDTA. In some embodiments, the anti-coagulant component is heparin.

In some embodiments, the hydrophilic substrate includes three fluid transfer channels fluidically coupled to the main channel, and where each of the three fluid transfer channels terminates in a separate diagnostic area. In some embodiments, the hydrophilic substrate includes three fluid transfer channels fluidically coupled to the main channel, and where each of the three fluid transfer channels terminates in a separate wicking area. In some embodiments, each diagnostic area includes a different liver function assay reagent. In some embodiments, a first and second fluid transfer channel have the same length, and wherein a third fluid transfer channel has a length which is less than either the first or second fluid transfer channels. In some embodiments, all fluid transfer channels have the same length.

In another aspect of the present disclosure is a microfluidic device comprising: at least two assay arrays, each assay array having a wax backing, and each assay array comprising: a hydrophilic substrate, the hydrophilic substrate comprising a main channel, at least two fluid transfer channels fluidically coupled to the main channel, wherein each of the at least two fluid transfer channels terminates in a separate diagnostic area, and wherein each of the separate diagnostic areas includes a different liver function assay reagent; wax on the hydrophilic substrate, the wax defining the boundaries of the main channel, the at least two fluid transfer channels, and the diagnostic areas; and wherein at least one of the assay arrays includes a calibration region.

In some embodiments, each fluid transfer channel includes an anti-coagulant component impregnated therein. In some embodiments, the liver function assay reagent includes a first component selected from the group consisting of a stabilizer and a catalyst, and at least one dye. In some embodiments, the liver function assay reagent is specific for albumin, alkaline phosphatase, alanine transaminase, aspartate transaminase (AST), total bilirubin, direct bilirubin, conjugated bilirubin, unconjugated bilirubin and/or total protein. In some embodiments, the device is configured such that quantities of albumin, alkaline phosphatase, alanine transaminase, aspartate transaminase, total bilirubin, and total protein are detected.

In another aspect of the present disclosure is a microfluidic device comprising: a hydrophilic substrate having at least six fluid transfer channels, wherein each of the six fluid transfer channels terminate in a discrete diagnostic area, wherein each of the at least six fluid transfer channels and discrete diagnostic areas are defined by wax boundaries on the hydrophilic substrate; and wherein a first discrete diagnostic area includes a first assay reagent specific for albumin, a second discrete diagnostic area includes a second assay reagent specific for alkaline phosphatase, a third discrete diagnostic area includes third assay reagent specific for alanine transaminase, a fourth discrete diagnostic area includes a fourth assay reagent specific for aspartate transaminase, a fifth discrete diagnostic area includes a fifth assay reagent specific for total bilirubin, and a sixth discrete diagnostic area includes a sixth assay reagent specific for total protein. In some embodiments, each of the at least six fluid transfer channels include one or more additives. In some embodiments, each of the at least six fluid transfer channels include an anti-coagulant agent. In some embodiments, at least two of the discrete diagnostic areas include different dyes. In some embodiments, at least three of the discrete diagnostic areas include different dyes. In some embodiments, the microfluidic device further comprises a calibration region. In some embodiments, the microfluidic device comprises at least two separate assay arrays. In some embodiments, three of the six discrete diagnostic areas are arranged in a first assay area; and another three of the six discrete diagnostic areas are arranged in a second assay area.

In another aspect of the present disclosure is an assay device comprising a porous, hydrophilic substrate; a fluid-impermeable barrier defining (i) a boundary of a main channel, (ii) boundaries of at least two fluid transfer channels, and (iii) boundaries of at least two diagnostic areas, the at least two fluid transfer channels each providing a fluidic pathway within the porous, hydrophilic substrate between the main channel region and a diagnostic area. In some embodiments, a bodily fluid is applied to the main channel or a fluid inlet in communication with the main channel. In some embodiments, the bodily fluid flows, such as through capillary action, through the main channel, into the fluid transfer channels, and into the diagnostic areas. In some embodiments, the diagnostic areas include one or more components which react with the bodily fluid, the reaction providing a diagnostic indication which may be quantified, the diagnostic indication being a detectable and/or quantifiable color change. In some embodiments, each diagnostic area includes at least one component indicative of liver disease or liver damage. In some embodiments, each diagnostic area includes at least one reagent which measures liver function. In some embodiments, each diagnostic area includes a liver function test selected from the group consisting of alanine transaminase (ALT) test, alkaline phosphatase (ALP) test, albumin test, total protein test, aspartate transaminase (AST) test, bilirubin test, gamma-glutamyltransferase (GGT) test, L-lactate dehydrogenase (LD) test, and a prothrombin (PT) test. In some embodiments, the assay device includes an anti-coagulant in each fluid transfer channel. In some embodiments, the assay device includes six diagnostic area. In some embodiments, the assay device includes six diagnostic areas divided into two separate assay arrays, each assay array having a single main channel and three fluid transfer channels.

### BRIEF DESCRIPTION OF THE DRAWINGS

For a general understanding of the features of the disclosure, reference is made to the drawings. In the drawings, like reference numerals have been used throughout to identify identical elements.

FIG. 1 illustrates a microfluidic device having three diagnostic areas in accordance with some embodiments of the present disclosure.

FIG. 2 illustrates a microfluidic device having two assay arrays in accordance with some embodiments of the present disclosure.

FIG. 3 illustrates a microfluidic device having three diagnostic areas, each diagnostic area including a wicking portion in accordance with some embodiments of the present disclosure.

FIG. 4 illustrates a microfluidic device having six diagnostic areas in accordance with some embodiments of the present disclosure.

FIG. 5 illustrates a microfluidic device having two diagnostic areas in accordance with some embodiments of the present disclosure.

### DETAILED DESCRIPTION

It should also be understood that, unless clearly indicated to the contrary, in any methods claimed herein that include more than one step or act, the order of the steps or acts of the method is not necessarily limited to the order in which the steps or acts of the method are recited.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of.” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The present disclosure provides for microfluidic devices configured to enable the flow of one or more fluids (such as bodily fluids, including blood or any fraction thereof) through one or more channels to a diagnostic area such that the one or more fluids may become in contact with one or more reagents present (e.g. embedded or impregnated) within the diagnostic area of the device. In some embodiments, a single sample of the one or more fluids diffuses through the channels (such as channels in the substrate) to react with different reagents in different diagnostic areas to provide a simple and low-cost device for performing multiple biochemical and/or medical and/or diagnostic tests (e.g. a liver panel) on a single fluid sample.

A “channel,” as used herein, means a feature on or in an article (e.g. a substrate) that at least partially directs the flow of a fluid. The channel can have any cross-sectional shape (circular, oval, triangular, irregular, square or rectangular, or the like). The channel may be of any size, for example, having a largest dimension perpendicular to fluid flow of less than about 20 mm, less than about 15 mm, less than about 10 mm, less than about 5 mm, less than about 2 mm, less than about 1 mm, less than about 500 microns, less than about 200 microns, or less than about 100 microns.

In some embodiments, the microfluidic device includes a substrate, wherein the substrate comprises a single sheet of material capable of transporting a liquid using capillary action; and a plurality of channel walls or boundaries formed on the substrate, wherein the channel walls or boundaries define fluid flow paths on the substrate, wherein a fluid added to the substrate is conducted through the fluid flow paths by capillary action. In an embodiment, the substrate comprises paper. In some embodiments, the channel walls or boundaries are formed from a liquid impermeable material. For example, the channel walls may be formed from a photoresist material, a solid wax material, or a solid ink.

In some embodiments, the microfluidic device includes a substrate, such as a hydrophilic substrate. As used herein, the term “hydrophilic substrate” refers to materials that absorb water and enable diffusion of the water through the material via capillary action. The substrate may be any porous, hydrophilic medium provided that it wicks fluids by capillary or diffusive action. In some embodiments, a substrate is selected such that it is compatible with a pattern method, such as a patterning method to deposit one or more compounds, e.g. wax, onto the substrate so as to define barriers or channels. As described below, a hydrophobic material is embedded on and/or in the hydrophilic substrate to form fluid channels and other hydrophobic structures that control the diffusion of the fluid through the hydrophilic substrate.

In some embodiments, the substrate is paper. Paper is inexpensive, widely available, readily patterned, thin, lightweight, and can be disposed of with minimal environmental impact. Furthermore, a variety of grades of paper are available, permitting the selection of a paper substrate with the weight (i.e., grammage), thickness and/or rigidity and surface characteristics (i.e., porosity, hydrophobicity, and/or roughness), desired for the fabrication of a particular paper-based device. Suitable papers include, but are not limited to, chromatography paper, card stock, filter paper, vellum paper, printing paper, wrapping paper, ledger paper, bank paper, bond paper, blotting paper, drawing paper, fish paper, tissue paper, paper towel, wax paper, and photography paper. In other embodiments, the substrate is nitrocellulose and cellulose acetate, cellulosic paper, filter paper, and porous polymer film.

In some embodiments, a hydrophobic material is deposited onto the surface of the substrate. As used herein, the term “hydrophobic material” refers to any material that resists cohesion to water and is substantially impermeable to a flow of water through capillary motion. When embedded in a porous substrate, such as paper, the hydrophobic material acts as a barrier to prevent the diffusion of water through portions of the substrate that include the hydrophobic material. The hydrophobic material also acts as a barrier to many fluids that include water, such as blood, urine, sputum, saliva, swab cultures, and other biological fluids. As described below, the hydrophobic material is embedded in and/or on a porous substrate to form channels and other hydrophobic structures that control the capillary diffusion of the liquid through the substrate.

In some embodiments, the hydrophobic material is arranged or patterned onto the surface of the substrate so as to define barriers, such that the various channels and/or diagnostic areas may be defined. The hydrophobic material forms channels to direct the fluid to different locations in the substrate that have deposits of reagents so as to provide a detectable and/or quantifiable result. The hydrophobic material is also substantially chemically inert with respect to the fluids in the channel to reduce or eliminate chemical reactions between the hydrophobic material and the fluids. In some embodiments, the hydrophobic material deposited and/or patterned onto the substrate is a wax.

The channels and diagnostic areas may be patterned using any suitable method known in the art. For example, the channels and diagnostic areas may be patterned using photolithography, plotting with an analogue plotter, ink jet etching, plasma treatment, paper cutting, wax printing, ink jet printing, flexography printing, screen printing, deposition printing, and laser treatment. The fundamental principle underlying these fabrication techniques is to pattern hydrophilic-hydrophobic regions on a substrate in order to create channels on the substrate, each of the channels being fluidically coupled to one or more diagnostic areas.

In some embodiments, the channels and/or diagnostic areas may be patterned by wax printing. In these methods, an inkjet or solid ink printer is used to pattern a wax material on the paper substrate. Many types of wax-based solid ink are commercially available and are useful in such methods as the ink provides a visual indication of the location of the hollow channel. However, it should be understood, that the wax material used to form the channel does not require an ink to be functional. Examples of wax materials that may be used include polyethylene waxes, hydrocarbon amide waxes or ester waxes. Once the wax is patterned, the paper substrate is heated (e.g., by placing the substrate on a hot plate with the wax side up at a temperature of 120° C.) and cooled to room temperature. This allows the wax material to substantially permeate the thickness of the paper substrate, so as to form a hydrophobic boundary that defines the dimensions of the channels and/or diagnostic areas.

In some embodiments, the substrate surface opposite the surface including the patterning and/or channels is coated with a fluid impermeable material, e.g. wax. For example, one side of the substrate may include a continuous fluid impermeable backing, while the other side may include the patterns and/or channels.

The microfluidic devices described herein can optionally include one or more additional elements, as required to provide a device with suitable functionality for a particular application. For example, the microfluidic device can optionally comprise one or more additional layers, such as a backing layer. The backing layer may be comprised of polymer (including, e.g. acrylates), metal, glass, wood, or paper support structure to facilitate handling and use of the device. In some embodiments, the devices described herein are affixed to or secured within an inert, non-absorbent polymer such as polydimethylsiloxane (PDMS), a polyether block amide (e.g., PEBAX®, commercially available from Arkema, Colombes, France), a polyacrylate, a polymethacrylate (e.g., poly(methyl methacrylate)), a polyimide, polyurethane, polyamide (e.g., Nylon 6,6), polyvinylchloride, polyester, (HYTREL®, commercially available from DuPont, Wilmington, Del.), polyethylene (PE), polyether ether ketone (PEEK), fluoropolymers such as polytetrafluoroethylene (PTFE), perfluoroalkoxy, fluorinated ethylene propylene, or a blend or copolymer thereof. In some embodiments, the backing is an adhesive tape, such as available from 3M. Silastic materials and silicon-based polymers can also be used. In some embodiments, the device further includes a covering, e.g. a barrier layer over the device that does not touch the microfluidic channels in order to protect the user from contamination.

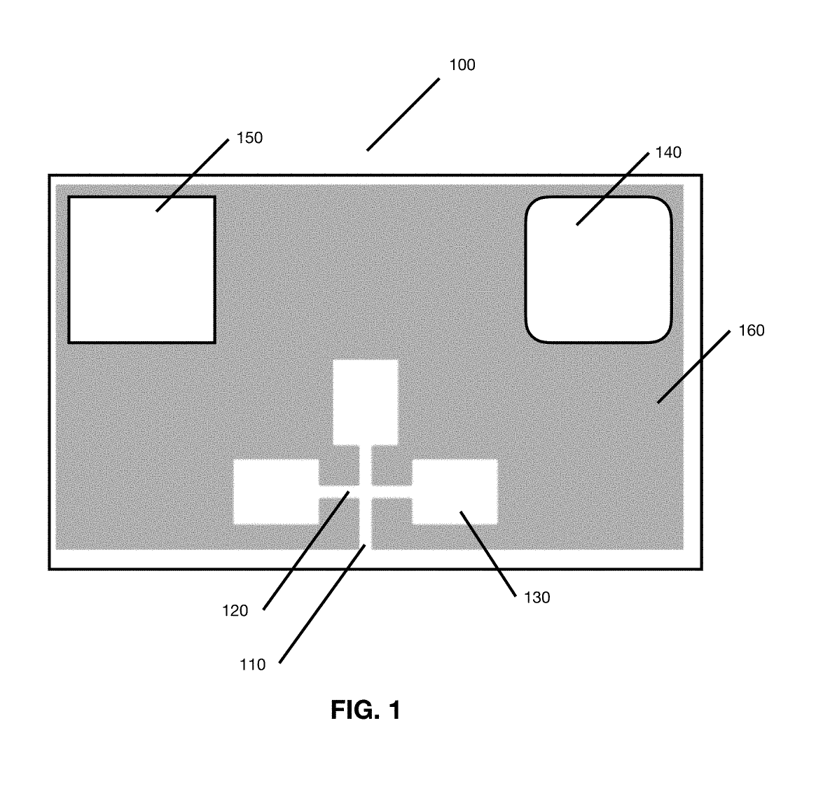

With reference to FIG. 1, the microfluidic device 100 may include a substrate onto which a hydrophobic material is applied, e.g. a wax, 160. In some embodiments, the hydrophobic material is patterned such that a main channel 110 is defined. In addition, the patterning facilitates the definition of fluid transfer channels 120 and diagnostic areas 130. In some embodiments, the microfluidic device 100 includes three fluid transfer channels 120 and three diagnostic areas 130, such as depicted in FIG. 1. In some embodiments, the main channel 110 has a length ranging from between about 3 mm to about 8 mm. In other embodiments, the main channel 110 has a width ranging from between about 1 mm to about 3 mm. In some embodiments, the diagnostic areas are each the same size. In other embodiments, the diagnostic areas may vary in size (e.g. perimeter or area) or shape.

In some embodiments, each of the fluid transfer channels 120 have the same dimensions. In other embodiments, at least one of the fluid transfer channels 120 differs from the remaining fluid transfer channels 120 in at least one dimension, either a length or width of the fluid transfer channel 120. In some embodiments, two of the fluid transfer channels 120 have the same dimensions, while the third fluid transfer channel 120 differs in at least one dimension. In some embodiments, two of the fluid transfer channels 120 have the same dimensions, while the third fluid transfer channel 120 is shorter in length. In some embodiments, the fluid transfer channels 120 are designed such that fluid flows through each of the channels at the same rate, such that fluid enters the diagnostic area at substantially the same time. In some embodiments, each diagnostic area 130 holds a volume of fluid ranging from between about 5 microliters to about 15 microliters.

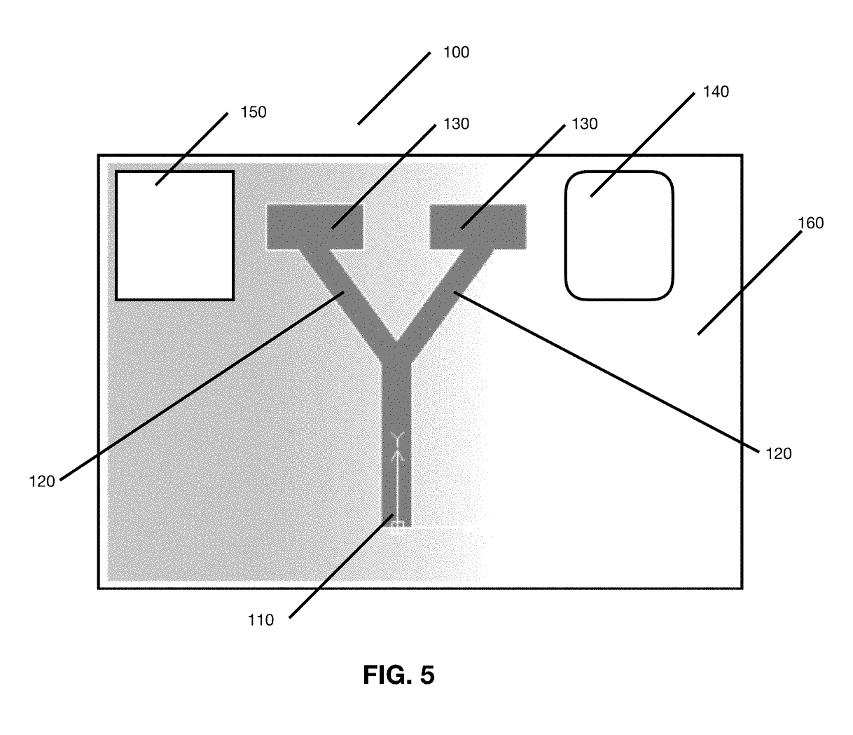

While FIG. 1 depicts a microfluidic device having three channels and three diagnostic areas, the microfluidic devices 100 of the present disclosure may contain any number of fluid transfer channels 120 and diagnostic areas 130 in fluidic communication with a main channel. For example, the microfluid device 100 may include two fluid transfer channels 120, each terminating in a diagnostic area 130, such as depicted in FIG. 5. In some embodiments, the main channel 110 is fluidically coupled with a fluid inlet (e.g. an area where a fluid may be deposited or applied).

In some embodiments, a filter is fluidically coupled to a main channel 110 via a fluid inlet. In some embodiments, the filter may have a mesh size which enables the entrapment of red blood cells. This filter may have different layers that can capture different sizes of cells and may trap different types of cells at different layers. Any patient blood will be placed directly on the filter and the blood will flow from the filter to the fluid inlet. In some embodiments, it will be placed in the main channel or in the cross section.

In some embodiments, the microfluidic device 100 may further include a calibration region 140. In some embodiments, the calibration region 140 includes colored indicia (e.g. circles of a single color) such that a camera may be calibrated to the colored indicia. In some embodiments, the calibration region allows the camera to recognize and control for changes in lighting hue and/or intensity. In some embodiments, the calibration region allows for focusing and/or to prevent or mitigate blurriness. In some embodiments, the microfluid device 100 may include further identifying indicia 150, including bar codes, QR codes, and alphanumeric information. In some embodiments, the identifying indicia 150 indicates a particular assay to be run, patient information, lot number, expiration date, hospital information, information of the person using the device, or tracking information as well as geolocating information. In some embodiments, the QR code contains information such as lot number, expiration date, and the test that is on the panel as well as the test order. The barcode can contain patient information and can be used to identify an unclaimed test. Such information that is inputted will also allow patient information to transfer into the Electronic Health Record.

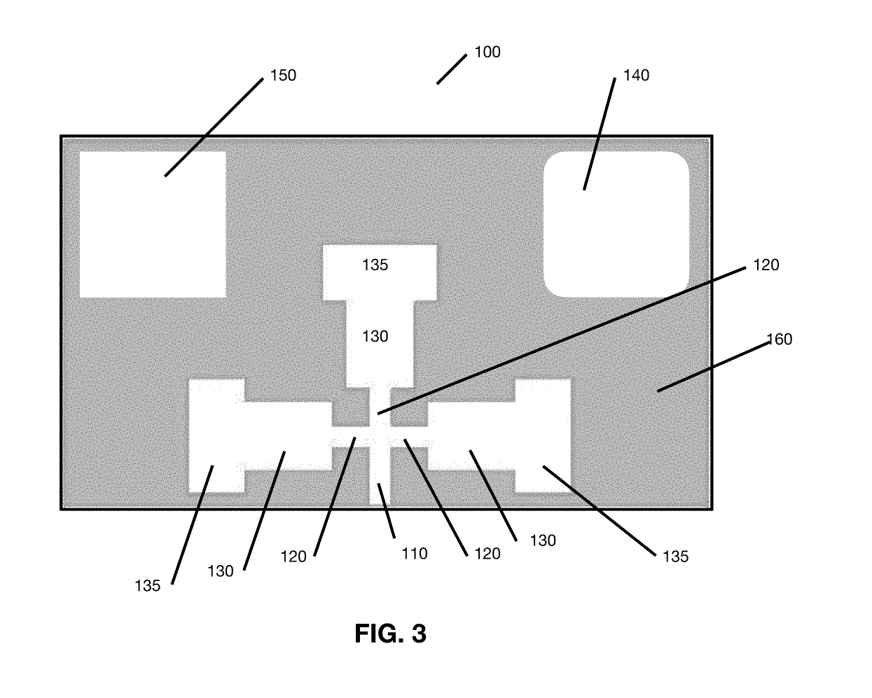

In some embodiments, and in reference to FIG. 3, the diagnostic areas 130 may including a wicking portion 135. It is believed that the wicking portion 135 serves to capture remaining blood and serve as protection from extra blood overflowing onto a common surface or onto the user. It also may speed the drying process. This wicking portion prevents fluid overflow and protects the user from possible spillage or overflow.

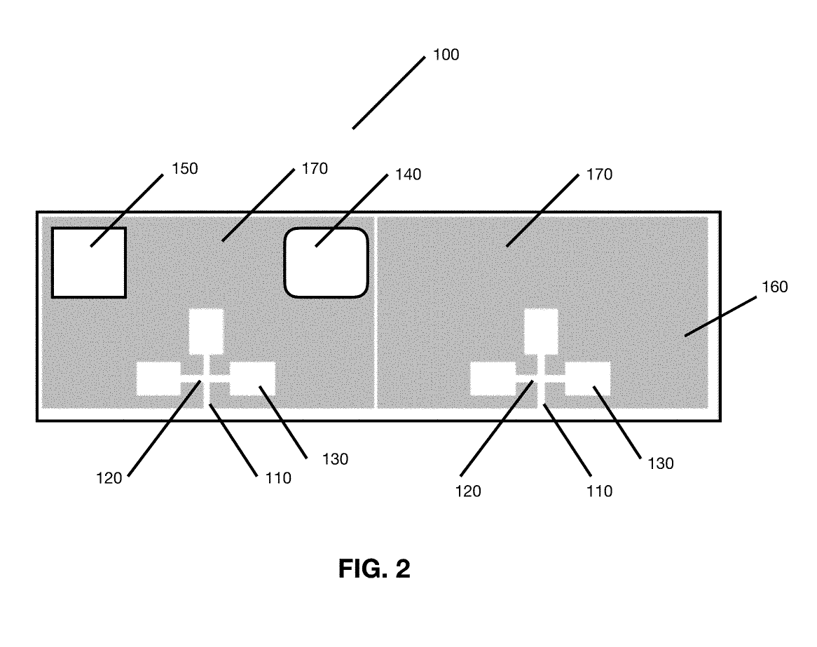

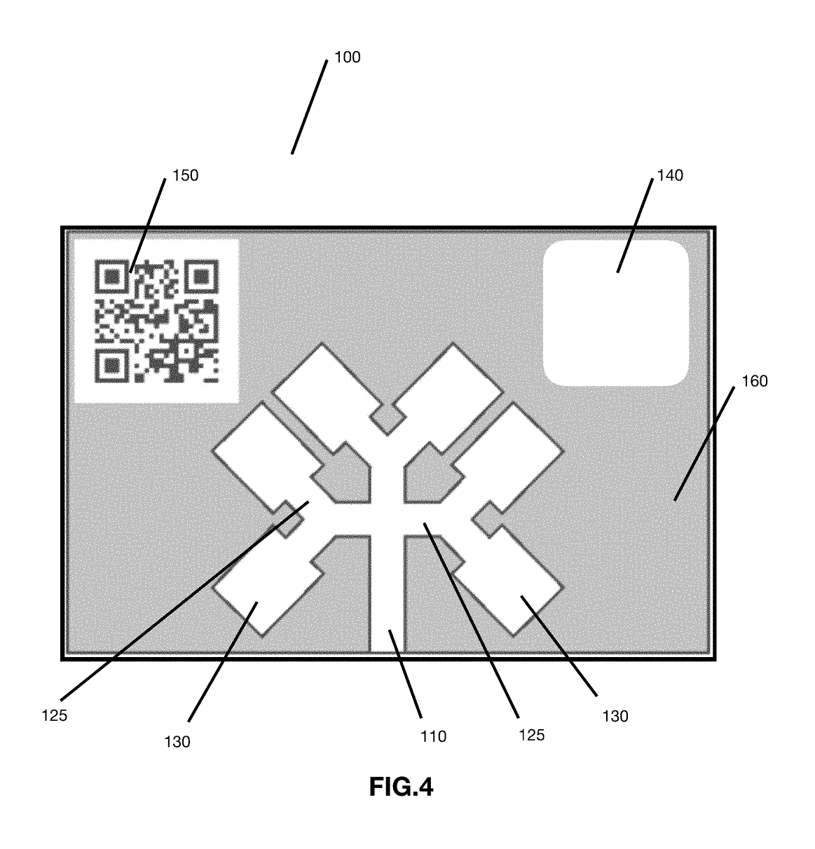

In some embodiments, the microfluidic device 100 include a plurality of assay arrays 170. In some embodiments, each assay array 170 has the same configuration and/or same arrangement, i.e. has the same number of fluid transfer channels 120 and the same number of diagnostic areas 130 (but differs in the reagents included in each diagnostic area). FIG. 2 illustrates a microfluidic device 100 having two assay arrays 170, each assay array having three fluid transfer channels 120, each fluid transfer channel 120 terminating in a diagnostic area 130. In other embodiments, each assay array 170 has a different configuration and/or different arrangement. For example, a first assay array could have the configuration of the microfluidic device of FIG. 1, which a second assay array could have the configuration of the microfluidic device of FIG. 3 or FIG. 4. While FIG. 2 depicts a microfluidic device 100 having two assay arrays, the microfluidic device 100 may include three, four, five, six, seven, eight, nine, ten, eleven, or twelve assay arrays each of which, again, may be the same or different.

In reference to FIG. 4, two or more diagnostic areas 130 may be fluidically coupled to the main channel 110 through a branched fluid transfer channel 125. While FIG. 4 depicts a microfluidic device 100 having three branched fluid transfer channels 125, each branched fluid transfer channel 125 fluidically coupled to a diagnostic area 130, the skilled artisan will appreciate that the microfluidic device 100 may include both branched fluid transfer channels 125 and fluid transfer channels 120 fluidically coupled to the main channel 110 in any configuration and in any arrangement as needed to include the desired number of diagnostic areas 130.

In some embodiments, one or more additives are deposited, embedded, or impregnated within the fluid transfer channels or branched fluid transfer channels. Additives include stabilizers, anti-coagulants, catalysts, lysing agents, nanoparticles, diluents, etc. In some embodiments, anti-coagulants are selected from ethylenediaminetetraacetic acid (“EDTA”) or heparin. In some embodiments, the one or more additives are located at any position along the fluid transfer channels. In some embodiments, the one or more additives are located at the same position in each fluid transfer channel. In other embodiments, the one or more additives are located at different locations in each fluid transfer channel.

In some embodiments, the microfluidic device further includes an assay reagent to aid in the detection and/or quantification of an analyte present in a fluid sample flowing through the channels and/or diagnostic areas. By way of example, the analyte can be a molecule of interest present in a fluid sample that is introduced into the channel. The analyte can be, for example, an antibody, peptide (natural, modified, or chemically synthesized), protein (e.g., a glycoprotein, a lipoprotein, or a recombinant protein), polynucleotide (e.g, DNA or RNA, an oligonucleotide, an aptamer, or a DNAzyme), lipid, polysaccharide, small molecule organic compound (e.g., a hormone, a prohormone, a narcotic, or a small molecule pharmaceutical), pathogen (e.g., bacteria, virus, or fungi, or protozoa), or combination thereof. In some embodiments, the analyte of interest is a component of blood, such as a protein or chemical typically found in blood.

The fluid sample can be a bodily fluid. The term “bodily fluid,” as used herein, refers to a fluid composition obtained from or located within a human or animal subject. Bodily fluids include, but are not limited to, urine, whole blood, blood plasma, serum, tears, semen, saliva, sputum, exhaled breath, nasal secretions, pharyngeal exudates, bronchoalveolar lavage, tracheal aspirations, interstitial fluid, lymph fluid, meningeal fluid, amniotic fluid, glandular fluid, feces, perspiration, mucous, vaginal or urethral secretion, cerebrospinal fluid, and transdermal exudate. Bodily fluid also includes experimentally separated fractions of all of the preceding solutions, as well as mixtures containing homogenized solid material, such as feces, tissues, and biopsy samples. The molecule of interest can be, for example, a biomarker (i.e., a molecular indicator associated with a particular pathological or physiological state) present in the bodily fluid that can be assayed to identify risk for, diagnosis of, or progression of a pathological or physiological process in a subject. Examples of biomarkers include proteins, hormones, prohormones, lipids, carbohydrates, DNA, RNA, and combinations thereof. In some embodiments, the bodily fluid may be mixed with another agent prior to being deposited onto the microfluidic device. For example, the bodily fluid may be diluted, such as in distilled water or in a buffer or transfer solution.

In some embodiments, the bodily fluid is deposited directly onto the main channel or a fluid inlet communicatively coupled thereto. For example, in some embodiments, the device is designed such that blood can be placed from a venous blood draw via an eyedropper or via a finger prick directly from the finger to the device to as to provide a sample deposited on the device. In some embodiments, and as discussed above, the device then draws the fluid to the testing zones where it reacts with reagents and begins to produce a color change. After an allotted elapsed time, in most cases 20 minutes or less, the reaction is complete and dried and is ready for interpretation.

The assay reagent can include a molecule or matrix that can selectively associate with the analyte. The term “selectively associates,” as used herein when referring to an assay reagent, refers to a binding reaction which is determinative for the analyte in a heterogeneous population of other similar compounds. Generally, the interaction is dependent upon the presence of a particular structure (e.g., an antigenic determinant or epitope) on the binding partner. By way of example, an antibody or antibody fragment selectively associates to its particular target (e.g., an antibody specifically binds to an antigen) but it does not bind in a significant amount to other proteins present in the sample or to other proteins to which the antibody may come in contact in an organism. Examples of such molecules include antibodies, antibody fragments, antibody mimetics (e.g., engineered affinity ligands such as AFFIBODY® affinity ligands), peptides (natural or modified peptides), proteins (e.g., recombinant proteins, host proteins), polynucleotides (e.g, DNA or RNA, oligonucleotides, aptamers, or DNAzymes), receptors, ligands, antigens, organic small molecules (e.g., antigen or enzymatic co-factors), and combinations thereof.

In some embodiments, the assay reagent can include a probe selected to facilitate radiological, magnetic, optical, and/or electrical measurements used to identify and/or quantify one or more analytes in a liquid sample. For example, the assay reagent can include a colorimetric probe, a fluorescent probe, a probe to facilitate the detection and/or quantification of an analyte, or combinations thereof, as discussed in more detail below. Colorimetric detection chemistries are typically related to enzymatic, chemical color-change reactions, and/or redox reactions.

In some embodiments, the assay reagent is deposited, embedded, or impregnated within a diagnostic area. In some embodiments, the diagnostic area includes one assay reagent. In other embodiments, the diagnostic area includes a plurality of assay reagents.

In some embodiments, the assay reagent is disposed in fluidic communication with the channels and/or diagnostic areas, such that, as fluid migrates through the flow path of the channels and/or diagnostic areas, the assay reagent contacts the analyte. Assay reagents can be added directly to the microfluidic device. In some embodiments, assay reagents can be deposited in discrete areas, using e.g. a micro-arraying tool, ink jet printer, spray, pin-based contact printing or screen-printing method.

In some embodiments, the microfluidic device may contain one or more diagnostic areas having one or more assay reagents selected so as to provide a response in the presence of an analyte that is visible to the naked eye. In some cases, the assay reagent can be an indicator that exhibits colorimetric and/or fluorometric response in the presence of the analyte of interest. Indicators may include molecules that become colored in the presence of the analyte, change color in the presence of the analyte, or emit fluorescence, phosphorescence, or luminescence in the presence of the analyte. In these embodiments, the presence of an analyte may be ascertained by simple visual examination, optionally under a blacklight. In some cases, the quantity of one or more analytes may be determined by visual inspection of the color or fluorescence of an assay region, for example, by comparison to known colors at predetermined analyte concentrations. The microfluidic device can optionally be configured such that the fluid sample and/or assay reagent can be interrogated using a digital camera, flatbed scanner, photographic film, or cellular phone.

In some embodiments, the microfluidic device is configured for hepatic panel testing or liver-function testing. In some embodiments, each diagnostic area includes a different liver assay reagent. A liver-function panel consists of several different assay reagents, which typically selectively associate with analytes, such as: aspartate transaminase (AST), alkaline phosphatase (ALP), alanine aminotransferase (ALT), bilirubin, albumin, and total serum protein. Other analytes that can provide diagnostically useful information include glucose, cholesterol, creatine, sodium, calcium, gamma glutamyl transferase (GGT), direct bilirubin, indirect bilirubin, unconjugated bilirubin, and lactate dehydrogenase (LDH).

In some embodiments, the liver assay reagent is comprised of multiple components. In some embodiments, each liver assay reagent includes at least a first component selected from a stabilizer or a catalyst; and a second component, e.g. a dye, colorant, chromogenic agent, etc. In some embodiments, the reagent includes 5-bromo-4-chloro-3-indolyl phosphate (BCIP), α-ketoglutarate, glucose oxidase, horseradish peroxidase, cholesterol oxidase, hydroperoxide, diisopropylbenzene dihydroperoxide, an apolipoprotein B species, 8-quinolinol, or monoethanolamine. In other embodiments, the reagent includes 2,4-dichloroaniline, 2,6-dichlorobenzene-diazonium-tetrafluoroborate, Bis (3′,3″-diiodo-4′,4″-dihydroxy-5′,5″-dinitrophenyl)-3,4,5,6-tetrabromosulfonephtalein (DIDNTB) or a derivative or salt thereof. In other embodiments, the reagent includes a phenolphthalein anionic dye. In some embodiments, the reagent includes nitro blue tetrazolium (NBT), methyl green, rhodamine B, 3,3′,5,5′-tetramethylbenzidine, a diaphorase, or methylthymol blue. In other embodiments, the reagent includes a diazonium salt and/or oxalacetic acid.

In some embodiments the reagent includes NBT and BCIP. In other embodiments, the reagent includes α-ketoglutarate, methyl green, and rhodamine B. In other embodiments, the reagent includes 3,3′,5,5′-tetramethylbenzidine, hydroperoxide, and diisopropylbenzene dihydroperoxide. In other embodiments, the reagent includes a phenolphthalein anionic dye and a diaphorase. In other embodiments, the reagent includes methylthymol blue, 8-quinolinol, and monoethanolamine.

In some embodiments, the assay for ALP includes BCIP and a dye. In some embodiments, the assay for AST includes), α-ketoglutarate and a dye. In some embodiments, the assay for ALT includes stabilized diazonium salt and oxalacetic acid. In some embodiments, the assay for bilirubin includes 2,4-dichloroaniline or 2,6-dichlorobenzene-diazonium-tetrafluoroborate. In some embodiments, the assay for albumin includes DIDNTB. In some embodiments, the assay for total protein includes tetrabromophenol blue (TBPB). In some embodiments, the assay for glucose includes a horseradish peroxidase, a glucose oxidase, and optionally a dye. In some embodiments, the assay for cholesterol includes a cholesterol oxidase, a horseradish peroxidase, and optionally a dye. In some embodiments, the assay for creatine includes 3,3′,5,5′-tetramethylbenzidine, hydroperoxide, and diisopropylbenzene dihydroperoxide. In some embodiments, the assay for sodium includes diaphorase and an apolipoprotein B species. In some embodiments, the assay for calcium includes 8-quinolinol and monoethanolamine. In embodiments where an assay includes multiple components, each component may be layered vertically onto each other.

### EXAMPLES

### Example 1—Manufacturing of a Microfluidic Device

Apparatus and Equipment

1. Xerox ColorQube 8570N Solid Ink Color Printer—2400 dpi

2. Filter paper

3. Hot plate

4. 3M Transpose clear tape

Steps

1. Wake the wax printer from sleep mode using the crescent moon button. Do not ever turn it completely on or off to avoid wasting time and ink (melted wax).

2. Mark one corner of a piece of paper and print the base-layer template onto it.

3. Cut masking tape into small squares and use it to attach filter paper to the sheet of paper. Line the filter paper up with the templates beneath so that you maximize the number of devices printed per run. This can involve cutting the edges of the filter paper.

4. Print the same template onto the sheet with filter paper attached, using the mark on the corner to orient it properly in the printer tray.

5. Detach the filter paper from the sheets and discard the sheets.

6. Turn on a hotplate and allow it to warm up. If there is a digital readout, then set it to 150° C. Heat each device for approximately 15 seconds. The ink should visibly seep into the filter paper. You can verify that heating is complete by viewing the back to see if the ink is visible from that side. Also, check that the wax has not melted into the channels as this is a sign of over-baking.

7. Mark one corner of a piece of paper and print the top-layer template onto it.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

Although the present disclosure has been described with reference to a number of illustrative embodiments, it should be understood that numerous other modifications and embodiments can be devised by those skilled in the art that will fall within the spirit and scope of the principles of this disclosure. More particularly, reasonable variations and modifications are possible in the component parts and/or arrangements of the subject combination arrangement within the scope of the foregoing disclosure, the drawings, and the appended claims without departing from the spirit of the disclosure. In addition to variations and modifications in the component parts and/or arrangements, alternative uses will also be apparent to those skilled in the art.

1-20. (canceled)

21. A microfluidic device, comprising:
a single sheet of porous, hydrophilic paper having a front surface comprising a main channel, at least two fluid transfer channels fluidically coupled to the main channel, and a separate diagnostic area fluidically coupled to each fluid transfer channel;
wax provided on the front surface of the paper, the wax defining boundaries of the main channel, the at least two fluid transfer channels, and the diagnostic areas;
a wax backing provided as a continuous coating on a back surface of the paper opposite the front surface; and
an assay reagent provided within at least one diagnostic area.

22. The microfluidic device of claim 21, further comprising a calibration region.

23. The microfluidic device of claim 21, further comprising a paper filter coupled to the main channel.

24. The microfluidic device of claim 21, comprising two to six fluid transfer channels.

25. The microfluidic device of claim 21, comprising three fluid transfer channels.

26. The microfluidic device of claim 21, wherein each diagnostic area comprises a different assay reagent.

27. The microfluidic device of claim 21, wherein each assay reagent comprises a probe.

28. The microfluidic device of claim 27, wherein the probe facilitates a radiological, magnetic, optical, and/or electrical measurement.

29. The microfluidic device of claim 27, wherein the probe is a colorimetric probe and/or a fluorescent probe.

30. The microfluidic device of claim 21, wherein:
a first assay reagent selectively associates with aspartate transaminase, alkaline phosphatase, alanine transaminase, bilirubin, albumin, total serum protein, glucose, cholesterol, creatine, sodium, calcium, gamma glutamyl transferase, direct bilirubin, indirect bilirubin, unconjugated bilirubin, or lactate dehydrogenase; and
a second assay reagent selectively associates with aspartate transaminase, alkaline phosphatase, alanine transaminase, bilirubin, albumin, total serum protein, glucose, cholesterol, creatine, sodium, calcium, gamma glutamyl transferase, direct bilirubin, indirect bilirubin, unconjugated bilirubin, or lactate dehydrogenase,
provided that the first and second assay reagents are different.

31. The microfluidic device of claim 21, further comprising identifying indicia on the front surface of the device.

32. A method of detecting at least two target analytes using the microfluidic device of claim 21, comprising:
(a) depositing a sample of bodily fluid onto the main channel or onto a paper filter coupled to the main channel;
(b) allowing the sample to flow into each diagnostic area, wherein each diagnostic area comprises an assay reagent that selectively associates with a target analyte, and wherein each assay reagent comprises a probe;
(c) allowing a chemical reaction to proceed between the sample and the assay reagent in each diagnostic area; and
(d) detecting the target analytes by observing a visual indication in each corresponding diagnostic area.

33. The method of claim 32, wherein at least one visual indication is a quantifiable color change.

34. The method of claim 32, wherein at least one of the target analytes is aspartate transaminase, alkaline phosphatase, alanine transaminase, bilirubin, albumin, total serum protein, glucose, cholesterol, creatine, sodium, calcium, gamma glutamyl transferase, direct bilirubin, indirect bilirubin, unconjugated bilirubin, or lactate dehydrogenase.

35. The method of claim 32, wherein the bodily fluid comprises blood.

36. The method of claim 32, wherein the assay reagent comprises a stabilizer.

37. The method of claim 32, wherein the assay reagent comprises a reaction catalyst.

38. The method of claim 32, wherein the chemical reaction comprises an enzymatic reaction, a chemical color-change reaction, and/or a redox reaction.

39. The method of claim 32, further comprising quantifying the target analytes based on the observed visual indications.
